(19) United States
(12) Patent Application Publication
(10) Pub. No.: US 2013/0235977 A1
(43) Pub. Date: Sep. 12, 2013

(54) Electromagnetic Scanning Apparatus for Generating a Scanning X-ray Beam

(71) Applicant: AMERICAN SCIENCE AND ENGINEERING, INC., Billerica, MA (US)

(72) Inventors: Lee Grodzins, Lexington, MA (US); Peter Rothschild, Newton, MA (US)

(73) Assignee: American Science and Engineering, Inc., Billerica, MA (US)

(21) Appl. No.: 13/768,925

(22) Filed: Feb. 15, 2013

Related U.S. Application Data
(60) Provisional application No. 61/607,232, filed on Mar. 6, 2012.

(51) Int. Cl. H01J 35/30

(52) U.S. Cl. CPC H01J 35/30
USPC 378/124; 378/137

(57) ABSTRACT

An apparatus for generating a scanned beam of penetrating electromagnetic radiation. An electron beam is incident on a succession of specific locations on a concave anode which emits electromagnetic waves in response thereto, in such a way that electromagnetic waves exiting from an aperture scan over a range of angles within a scan plane in response to angular scanning of the electron beam. The x-ray beam is extracted from the apparatus via one or more exit apertures in the back hemisphere, on the side of the anode onto which the electron beam impinges.

The present application claims the priority of U.S. Provisional Patent Application Ser. No. 61/607,232, filed Mar. 6, 2012, which is incorporated herein by reference.

### TECHNICAL FIELD

The present invention relates a source of scanned x-ray radiation, and, more particularly, to an apparatus for generating a scanned x-ray beam by electromagnetic scanning of a beam of charged particles with respect to a concave target surface.

### BACKGROUND ART

Scanning x-ray beams generated by electromagnetically scanning a pencil beam of electrons over an anode have been envisioned from many years, though no commercial systems are yet available. All of the methods use the so-called transmission arrangement, exemplified in FIG. 1 and described in U.S. Pat. No. 6,282,260 (to Grodzins, entitled “Unilateral Hand-Held X-ray Inspection Apparatus”), which is incorporated herein by reference. Beam 20 of electrons emitted by cathode 18 is accelerated toward target 22, typically an anode, and referred to, hereinafter, as such. Electron beam 20 may be scanned with respect to anode 22 such that the orientation of beam 14 may be varied. In this example, the generated x-rays exit out of the thin, typically high-Z, anode into a conical enclosure, and only exit from an aperture at the apex of the cone. Other examples of scanning x-ray beams produced by scanning electron beams are listed below. In all cases the x-rays emanate in the forward hemisphere.

Other configurations of electromagnetically steered x-ray beams entailing a geometry based on bremsstrahlung emission in the forward direction are described, for example, in U.S. Pat. No. 6,421,420 (to Grodzins, entitled “Method and Apparatus for Generating Sequential Beams of Penetrating Radiation”) and U.S. Pat. No. 6,542,574 (to Grodzins, entitled “System for Inspecting the Contents of a Container”), both of which patents are incorporated herein by reference.

### SUMMARY OF EMBODIMENTS OF THE INVENTION

In accordance with various embodiments of the present invention, an apparatus is provided for generating a scanned beam of penetrating electromagnetic radiation. The apparatus has a source for producing an electron beam characterized by a propagation direction and an anode for receiving the electron beam and emitting electromagnetic waves in response thereto. The apparatus also has an electromagnetic beam director for directing the propagation direction of the electron beam such that electrons impinge upon a succession of specified locations on the anode, and an exit aperture for emitting electromagnetic waves from the succession of specific locations on the anode, such that a direction of a beam of electromagnetic waves exiting from the aperture scans over a range of angles within a scan plane in response to angular scanning of the electron beam, wherein the scan plane is displaced from the propagation direction of the electron beam by at least 45 degrees.

In accordance with other embodiments, an apparatus for generating a scanned beam of penetrating electromagnetic radiation is provided that has a source for producing an electron beam, and an anode having a concave surface as viewed from the source, where the anode receives the electron beam and emits electromagnetic waves. An electromagnetic beam director directs the electron beam to a succession of specified locations on the anode, and electromagnetic waves are emitted via an exit aperture in direction that are scanned in response to angular scanning of the electron beam.

In any of the foregoing embodiments, the electromagnetic beam director may scan the electron beam within an electron beam plane. The exit aperture may lie within the electron beam plane in certain embodiments, although, in other embodiments, it may lie outside the electron beam plane.

In further embodiments of the invention, the apparatus may have multiple exit apertures. The electromagnetic beam director may be adapted to switch the electron beam in a lateral plane transverse to the electron beam plane. The apparatus may have a plurality of anodes, and a filter may be disposed within one or more exit aperture.

### BRIEF DESCRIPTION OF THE FIGURES

The foregoing features of the invention will be more readily understood by reference to the following detailed description, taken with reference to the accompanying figures, in which:

FIG. 1, shows a prior art electronic beam scanner, as described U.S. Pat. No. 6,282,260.

FIG. 2 is a conceptual drawing of an electronic beam scanner having a “one-sided” reflection geometry in accordance with an embodiment of the present invention.

FIG. 3 is a schematic cross-section, as viewed from above, of a reflection-scanned x-ray beam system in accordance with an embodiment of the present invention, showing the plane of a resulting x-ray beam taking off at an angle of about 150° from the plane of the scanning electron beam.

FIG. 4 a schematic cross-section, as viewed from above, of a stereoscopic reflection-scanned x-ray beam system in accordance with an embodiment of the present invention, for generating two simultaneous scanning x-ray beams.

### DETAILED DESCRIPTION OF EMBODIMENTS OF THE INVENTION

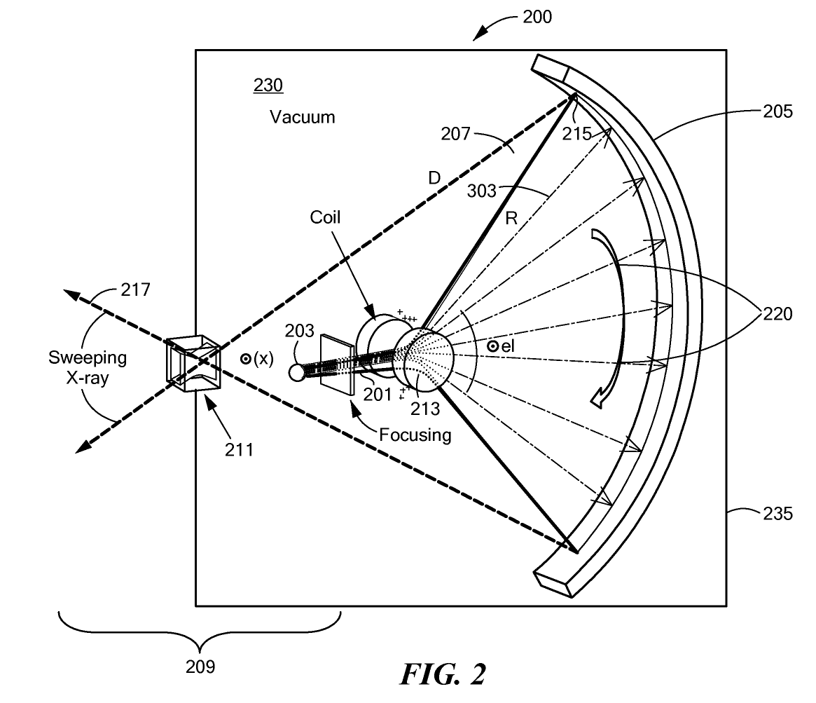

In accordance with embodiments of the present invention, now described with reference to FIG. 2, a reflection geometry is employed to generate a scanning x-ray beam 217. Electrons 201 derived from a cathode source 203 are accelerated toward an anode 205 in an electron beam 303 characterized by a propagation direction which is varied with time as described below.

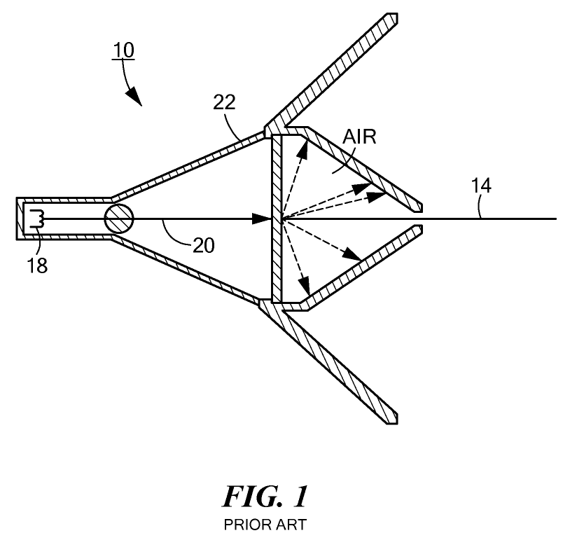

In the embodiment of the invention depicted in FIG. 2, anode 205 has a concave surface as viewed from source 203, such as a circular arc. However, it is to be understood that anode 205 may have any shape, within the scope of the present invention. X-rays 207, generated by a bremsstrahlung process at anode 205, are emitted in the back hemisphere 209, exiting from an aperture 211 in that hemisphere. The present invention is described herein in terms of x-ray radiation for heuristic convenience and without limitation, although it is to be understood that any penetrating radiation derived in the bremsstrahlung process described is within the scope of the present invention. The reflection arrangement, shown in the drawings of FIGS. 2, 3 and 4, is versatile, with a number of advantages over the prior art transmission geometry represented in FIG. 1.

An embodiment of the present invention having a spherical surface of radial distance, R, (shown in FIG. 2) between an electromagnetic beam director 213, such as the scanning magnet shown (which may be referred to herein as scanning magnet 213, or otherwise as a “sweeping magnet”) and anode 205, eliminates complications otherwise encountered, in the case of a planar anode, in making a uniform focal spot 215 of electrons at all points as would be called for in the case of a planar anode. However, in other applications, anodes of flat, or other, shape may be preferred.

Focal spot 215, where electrons of electron beam 303 impinges upon anode 205, is the origin focal point of the sweeping x-ray beam 217, and the dimensions of that focal point 215 are also independent of the sweep angle θₑₗ. Sweeping x-ray beam 217 may be referred to herein as a “reflection-scanned x-ray beam.” In certain embodiments of the invention, electromagnetic beam director 213 sweeps electron beam 303 is a plane (in FIG. 2, the plane of the page), which may be referred to as the “electron beam plane.”

The nearly constant distance D from all points of the arc of anode 205 to the exit aperture 211, produces a uniform sweeping x-ray beam 217 across a target (not shown).

Scanning electron beam 220 and scanning x-ray beam 217 occupy comparable volumes so that the size of the overall system can be smaller, and the shielding can be lighter, than in the traditional geometry.

The “plane” of the scanning electron beam 220 and the plane of the scanning x-ray beam 217 may be made no more than a few mm thick. (As used herein, the term “plane” may be used to represent the time-integral of the path of a swept beam. Insofar as the beam is not one-dimensional, but has a finite cross-section, the term “plane” has a finite thickness, although the thickness may be ignored for most descriptive purposes.) The plane in which x-ray beam 217 sweeps is referred to herein as the “scan plane.”

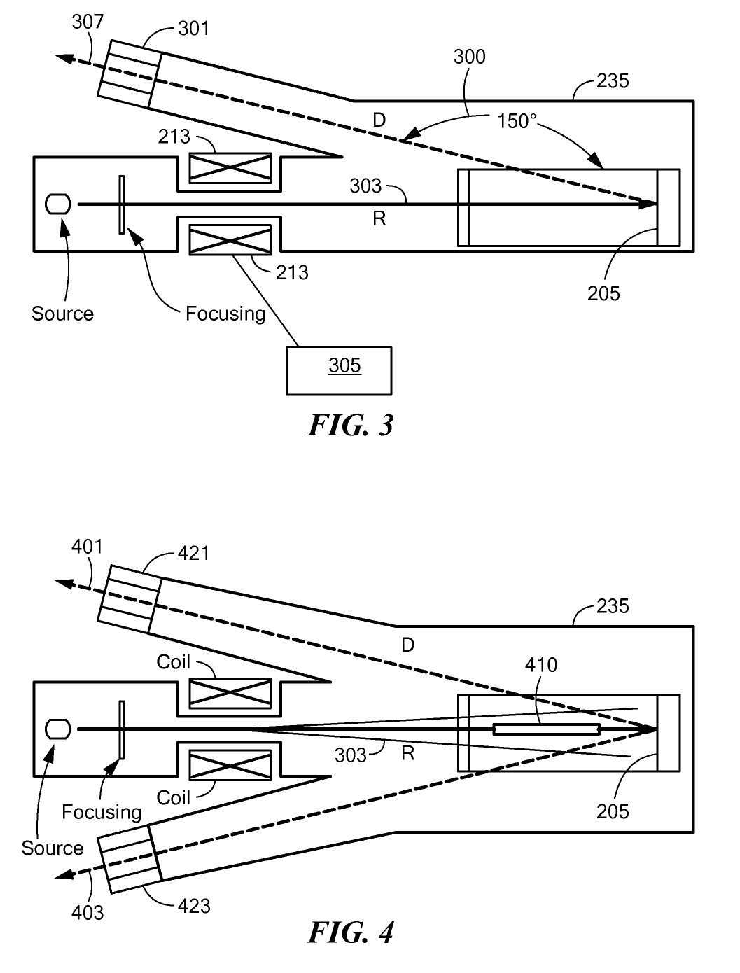

The sweeping magnet 213 may be disposed outside a vacuum space 230 within vacuum housing 235 enclosing the electron source 203 and anode 205. There is considerable latitude for positioning the exit aperture 211. FIG. 3 shows one example where an exit aperture 301 is offset from a plane containing the sweeping electron beam 303. Angle 300 refers to the angle between electron beam 303 and the direction at which x-ray beam 307 is taken off. Within the scope of the present invention, angle 300 includes angles that are greater than 45°.

In accordance with embodiments of the present invention, the electron focus and the magnetic sweep are under control of a processor 305 such that a desired sweep pattern can be preprogramed or changed under operator command. For example, the angular sweep of the x-ray beam 307 can be easily changed by changing the angular sweep of the electron beam 303.

A true-focus system, in which the total x-ray flux on target remains constant as scan angle is changed, can be implemented by changing the distance D from anode 205 to exit aperture 301 while changing the size of the aperture appropriately.

Referring, now, to the cross-sectional view of FIG. 4, as seen from above, two (or more) similar scanning x-ray beams 401 and 403, one on each side of the electron scanning plane, can be simultaneously used for stereoscopic imaging of transmitted or scattered x-rays. In accordance with other embodiments of the invention, electron beam 303 may, additionally, be switched in a lateral plane (in the plane of the cross-section shown in FIGS. 2-4). By switching beam 303 laterally, and by disposing x-ray-opaque element 410 in the path of x-rays emitted by anode 205, x-ray emission may be alternated temporally between beams 401 and 403.

Additionally, in accordance with yet further embodiments of the invention, multiple anodes may be provided, thereby providing distinct spectral characteristics during periods which electron beam 303 dwells on respective anodes. Apertures 421 and 423 may contain filters (or, alternatively, filters may be provided within other portions of the respective x-ray beams) such that the energy spectra of respective beams 401 and 403. (or portions thereof) may be tailored.

The x-ray-defining aperture 301 (shown, for example, in FIG. 3), together with changeable filters and an x-ray shutter, may be inside or, in a preferred embodiment, placed outside the vacuum 230.

For heuristic convenience, the invention is described herein, without limitation, in terms of the scanning a pencil beam of x-rays in a plane. The invention can also be applied, for example, to a two-dimensional scan, in a raster fashion, or otherwise. In a preferred two-dimensional embodiment, anode 205 is a segment of a hollow sphere.

The one-sided scanning system, designated generally by numeral 200 in FIG. 2, can be applied to a wide range of applications, from large systems that scan trucks with x-rays extending to hundreds of keV, to hand-held systems that scan with beams of less than 100 keV. For electron energies below a few hundred keV, the bremsstrahlung angular distribution is essentially isotropic from a target thick compared to the electron range. Model calculations show that, in the energy range of interest, the x-ray intensity in the 180° (back) direction is, in fact, greater than the x-ray intensity at 90°.

The described embodiments of the invention are intended to be merely exemplary and numerous variations and modifications will be apparent to those skilled in the art. All such variations and modifications are intended to be within the scope of the present invention as defined in the appended claims.

Where examples presented herein involve specific combinations of method acts or system elements, it should be understood that those acts and those elements may be combined in other ways to accomplish the same objective of x-ray detection. Additionally, single device features may fulfill the requirements of separately recited elements of a claim. The embodiments of the invention described herein are intended to be merely exemplary; variations and modifications will be apparent to those skilled in the art. All such variations and modifications are intended to be within the scope of the present invention as defined in any appended claims.

We claim:

1. An apparatus for generating a scanned beam of penetrating electromagnetic radiation, the apparatus comprising:
a. a source for producing an electron beam characterized by a propagation direction;
b. an anode for receiving the electron beam and emitting electromagnetic waves in response thereto;
c. an electromagnetic beam director that directs the propagation direction of the electron beam such that electrons impinge upon a succession of specified locations on the anode; and
d. an exit aperture for emitting electromagnetic waves from the succession of specific locations on the anode, such that a direction of a beam of electromagnetic waves exiting from the aperture scans over a range of angles within a scan plane in response to angular scanning of the electron beam, wherein the scan plane is displaced from the propagation direction of the electron beam by at least 45 degrees.

2. An apparatus for generating a scanned beam of penetrating electromagnetic radiation, the apparatus comprising:
a. a source for producing an electron beam;
b. an anode having a concave surface as viewed from the source, the anode receiving the electron beam and emitting electromagnetic waves in response thereto;
c. an electromagnetic beam director that directs the electron beam to a succession of specified locations on the anode; and
d. an exit aperture for emitting electromagnetic waves emitted at the succession of specific locations on the anode, such that a beam of electromagnetic waves exiting from the aperture is scanned in response to angular scanning of the electron beam.

3. An apparatus in accordance with claim 1 or 2, wherein the electromagnetic beam director is adapted to sweep the electron beam within an electron beam plane.

4. An apparatus in accordance with claim 3, wherein the exit aperture lies within the electron beam plane.

5. An apparatus in accordance with claim 3, wherein the exit aperture lies outside the electron beam plane.

6. An apparatus in accordance with claim 3, further comprising a plurality of exit apertures.

7. An apparatus in accordance with claim 1 or 2, wherein the electromagnetic beam director is further adapted to switch the electron beam in a lateral plane transverse to the electron beam plane.

8. An apparatus in accordance with claim 1 or 2, further comprising a plurality of anodes.

9. An apparatus in accordance with claim 1 or 2, further comprising a filter disposed within the exit aperture.
